(19) United States
(12) Patent Application Publication
(10) Pub. No.: US 2025/0382760 A1
(43) Pub. Date: Dec. 18, 2025

(54) STRUCTURED SEAWALL AND METHOD OF MANUFACTURE THEREOF

(71) Applicant: MIGHTY SEAWALL INC., Miami, FL (US)

(72) Inventors: Juan Sebastian Chiriboga, Homestead, FL (US); Diego Sarmiento Mejia, Miami, FL (US); Arnold Flores, Miami, FL (US); Jeremy Morris, Georgetown, TX (US); Leandro Fernandez, Miami, FL (US); Imran Adamjee, Miami, FL (US)

(21) Appl. No.: 19/241,789

(22) Filed: Jun. 18, 2025

Related U.S. Application Data
(60) Provisional application No. 63/661,141, filed on Jun. 18, 2024.

(51) Int. Cl. E02B 3/06; B33Y 80/00

(52) U.S. Cl. CPC E02B 3/06; B33Y 80/00

(57) ABSTRACT

A method for forming a panel for a seawall, the panel having a frame and a typographical member disposed thereon comprising the steps of creating a panel design by designing the typographical member to be substantially not planer and include discontinuities in an outward facing surface of the typographical member. The design is uploaded to a 3D printer. A support array is placed in position, either before or during printing. Printing an outer shell of the design from mortar, with the 3D printer, in a vertical direction about the array. Horizontal connectors are printed within an interior of the shell, so that an interior void in the panel is contiguous. The interior void is filled with concrete.

### BACKGROUND OF THE INVENTION

The present invention is directed to a seawall and more particularly to a method of manufacture of a three-dimensional concrete printed, ecologically friendly seawall having a water facing structure which promotes biodiversity.

Sea levels are rising. Conventionally this issue has been addressed by improved pumping and drainage, and more recently the adoption of the ancient practice of seawalls. In the centuries, not much has changed in the structure and use of seawalls; other than some use of materials. Many of these materials and structures are ill suited for seawall use, particularly where a goal is to promote biodiversity. Some prior art walls destroy marine habitats.

While these seawalls were satisfactory, they often result in the destruction of marine habitats and require extensive environmental mitigation measures in coastal regions. This destruction is primarily attributed to two reasons:
1. Leaching of Traditional Concrete: Traditional concrete mixes used in seawall construction tend to leach harmful substances into the water, negatively impacting marine ecosystems and decreasing the performance of the seawall.
2. Lack of Attachment Surfaces: The flat and smooth surface of traditional seawalls do not provide suitable conditions for marine life to attach and thrive, which is advantageous for sea life and improves the performance of the seawall.

Previous attempts to enhance the ecological aspects of seawalls focused primarily on material innovations aimed at addressing the leaching issue (reason 1). These innovations typically involve increasing the pH of the materials to attract flora and fauna. However, the physical structure of the seawall (reason 2) has remained largely unaddressed. Consequently, even if a seawall is constructed using more ecologically friendly materials, organisms still struggle to attach to a flat surface. Also, the cost, accuracy and safety issues with placing a heavy seawall remain.

Prior art construction methodology relies on molding, which severely limits its effectiveness. The molding process is time-consuming, costly, when it involves complex shapes, and lacks scalability or freedom of customization. This inherent restriction hampers the adaptability of seawalls to diverse environments and obstructs the creation of structures tailored to support local flora and fauna. The substantial expenses associated with molding seawall panels to incorporate the essential details required for attracting bio-organisms further compound the issue, rendering molded “living seawalls” cost-prohibitive and not scalable for most coastal communities. Therefore, typographical or 3D printing of a seawall is an improvement over the prior art molding process.

Furthermore, the prior art molding process suffers from the disadvantage that the molded wall requires special molds, limiting variability in design, both on the outside and inside, takes hours to fully set, and is heavy to move and locate at a predetermined place, limiting the ability to transport the finished product.

It is known to print seawalls and provide an internal corrugated or similar structure. However, if printed from concrete the seawalls tend to have the disadvantage of leaching. Also, a corrugated structure will not to provide sufficient structural integrity during shipment and use.

Accordingly, a system which overcome the shortcomings of the prior art is desired.

### SUMMARY OF THE INVENTION

A panel for a seawall has a main body frame. The main body frame may be 3D printed from mortar, and has a first area forming part of a front surface. The front surface is substantially planar and the panel is substantially hollow. A typographical member, or member created using 3D printing, is disposed on the main body frame having a second area, less than the first area. The typographical portion extends in a direction away from the main body frame and forms an uneven surface, the surface having at least one discontinuity or tunnel therein having a depth of at least three inches. The main body frame and typographical member may be formed, or printed, simultaneously from mortar. The main body frame has an interior, the interior being filled with concrete.

In one embodiment of the invention the at least one discontinuity is a blind hole. The typographical portion having a size and being disposed on the frame, so that the main body frame extends beyond at least three sides of the typographical portion.

In another embodiment of the invention, the main body frame and the typographical portion are formed as a unitary structure. The frame is hollow. A structure is disposed within the frame across the width of the frame and along the length of the frame within the hollow portion. The structure may be an array, and the array may be comprised of rebar.

In another embodiment of the invention sensors for measuring water quality among other things are disposed in the panel.

In a further embodiment of the invention, the panel has a thickness. The thickness of the frame being about twice the thickness of the typographical portion.

In another embodiment of the invention the panel is formed by 3D printing by first creating a panel design and uploading the design to a 3D printer. A support array is provided. An outer shell of the design is printed from mortar in a vertical direction about the array with the 3D printer. Columns are printed within an interior of the shell, the columns forming chambers. The chambers are then filled with concrete.

### BRIEF DESCRIPTION OF THE DRAWINGS

The features and advantages of the present invention will become more readily apparent from the following detailed description of the invention in which like elements are labeled similarly.

FIG. 1 is a top perspective view of a panel constructed in accordance with the invention.

FIG. 2 is a top perspective view of a panel for a structured seawall constructed in accordance with a second embodiment the invention.

FIG. 3 is a top perspective view of a panel constructed in accordance with a third embodiment of the invention.

FIG. 4 is a sectional view taken along line 4-4 of FIG. 1.

FIG. 5 is a sectional view taken along line 5-5 of FIG. 1.

FIG. 6 is a sectional view taken along line 6-6 of FIG. 1.

FIG. 7 is flowchart for the method of manufacture of the seawall panel in accordance with an embodiment of the invention.

FIG. 8 is a perspective view of a panel during 3D printing construction in accordance with a non-limiting embodiment of a method of the invention.

FIG. 9 is a cut-away front perspective view of a 3D printed version of a non-limiting embodiment of the invention, illustrating support elements in the interior of a panel of the invention.

FIG. 10 is a perspective view of a version of a panel during 3D printing construction in accordance with a non-limiting embodiment of a method of the invention.

### DETAILED DESCRIPTION OF THE PREFERRED EMBODIMENTS

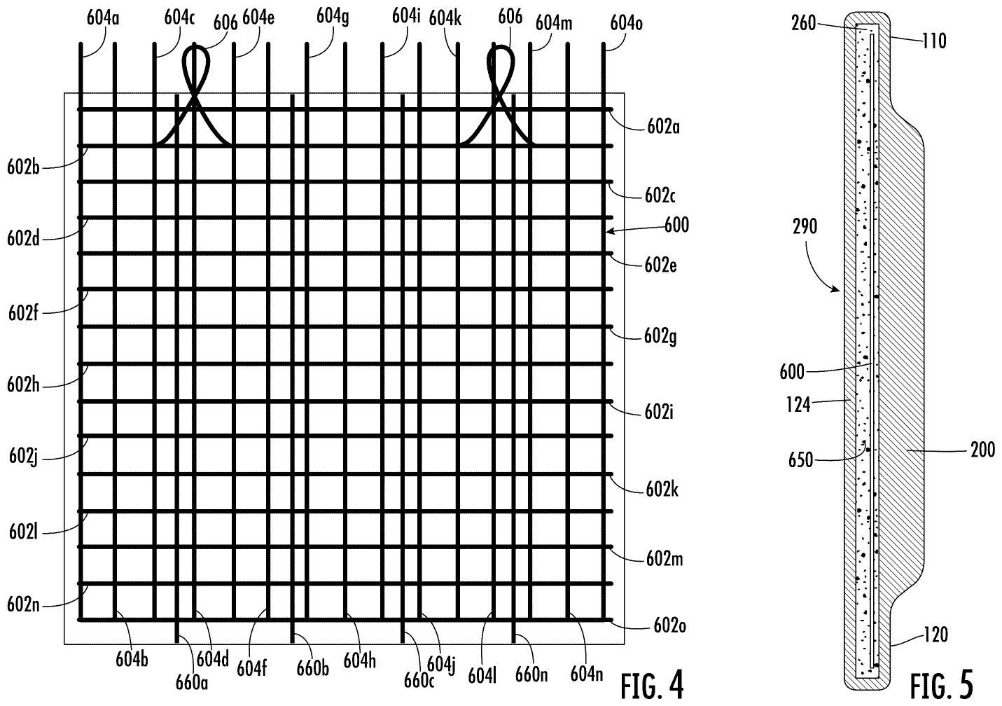

Reference is now made to FIGS. 1-6 in which a panel for a seawall, generally indicated as 100, constructed in accordance with the invention is provided. Panel 100 has a front wall 120 coupled to, and spaced from, a rear wall 124 (FIG. 5) by respective spaced side walls 122 and 126 forming an hollow interior 260. Front wall 120 forms a frame 102 having a first area 103. A front surface 110 of wall 120 forms frame 102, which is substantially planar to form a substantially flat surface. The planar frame 102 allows for traditional seawall panel installation methods, so that contractors who use the living seawall panels of the present invention can install them in the identical way that they install traditional, flat seawall panels. The front wall 120, rear wall 124 and respective side walls 122 and 126 may be created simultaneously by 3D printing. They may be created with a bottom portion or a bottom portion may be provided as a base for the 3D printing. Alternatively, the walls 120, 124, 122, 126 may be formed so that a portion of a provided rebar frame extends from a lower portion of the panel which may be used to fasten the panel to a base at a future time.

A typographical member, generally indicated as 200, is a three-dimensional printed structure, disposed on, and preferably integrally formed with, front surface 110 of wall 120. As shown in FIG. 1, typographical member 200 has a typographical area 201 less than the first area 103. Typographical member 200 has a substantially uneven surface 201. In the exemplary embodiments the uneven surface 201 of the typographical member 200 faces away from frame 102 and is formed of a plurality of lands or areas 216 separated by at least one, but preferably more than two, discontinuities 214. In FIG. 1, the discontinuities 214 may be partial or full valleys or depressions, rock-shaped protrusions or indentations, one or more blind holes or similar structures.

In a preferred embodiment, at least one discontinuity 214 is at least three inches deep. Preferably, an uneven surface 201 is formed of two or more non planer elements of the same or different heights separated by at least one discontinuity 214 in the uneven surface 201. Instead of one typographical member, several small typographical members may be located on the front surface.

By providing an uneven surface 201 to typographical member 200, the uneven surface 201 is a zone which mimics natural formations, such as mangrove tree roots or coral reefs. The uneven surface 201 provides an area for flora and fauna to latch onto and grow. By having discontinuities 214 (e.g., valleys, depressions) of at least three inches, sufficient depth is provided for sea animals to hide from predators, just as they would in nature on a coral reef or on a cliff, or even rock face.

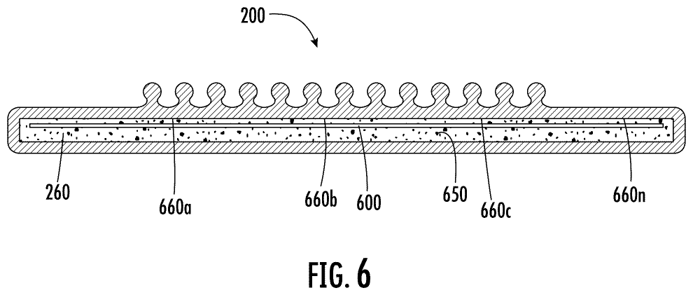

As seen from the sectional views of FIGS. 5 and 6, panel 100 is substantially hollow having an interior 260. The panel comprises a lightweight mortar so as to be printable as well as transportable and maneuverable on site. The mortar is also preferably resistant or impervious to leaching. To provide sufficient structural integrity to panel 100, a crisscrossed reinforcement array 600, an example of which is shown in FIG. 4, is provided. The array, preferably comprising rebar in a non-limiting example, is disposed within an interior 260 of panel 100. The array 600 engages sidewalls 122, 126. In a preferred non limiting embodiment, the array 600 includes a plurality of spaced horizontal bars 602a-6020 and a plurality of spaced vertical bars 604a-6040. Each of horizontal bars 602a-6020 and each of spaced vertical bars 604a-6040 preferably engages structural elements on or in the interior surface of the respective sidewalls 122, 126 of panel 100 to provide structural integrity to panel 100.

IN an alternative embodiment, instead of or with the structural array, corrugations may be formed by 3D printing or inserted by means known in the art into in the interior portion of a of the panel.

In a preferred embodiment, the mortar forming the panel is lighter weight than concrete. Furthermore, the mortar may be non-leaching or low-leaching. In a preferred embodiment, the mortar is quick-curing and may be of a type which has an initial set cure in about three minutes that is commercially available. In one preferred embodiment, shown in FIG. 5, the joining of the front wall 120 coupled to, and spaced from, a rear wall 124 by the respective spaced side walls 122 and 126 (not shown) forms a mortar shell 290. The mortar shell 290 forms a nontoxic water facing surface having a lighter than concrete exterior. The shell 290 is also a lighter because it is generally hollow. The interior 260 of the mortar shell 290 may be filled with concrete 650 about the array 600. Concrete 650 provides structural integrity to panel 100.

The shell 290, unfilled or filled with concrete, provides a lighter panel 100 than prior art seawalls without sacrificing structural integrity. Additionally, the planar frame as described above, allows for traditional installation methods, so that contractors who use the living seawall panels can install them in the identical way that they install traditional, flat seawall panels. Moreover, the mortar shells of the panels may be installed, and the concrete placed in the interior. The concrete may alternatively be placed in the interior 260 near the place of installation, lowering shipping and installation costs, and reducing the risk that a filled panel 100 may be broken. Lastly, the mortar shell may encapsulate the concrete after the concrete is inserted in the interior, thereby preventing or reducing the leaching of concrete into the water.

In one embodiment, dividers are formed at spaced intervals within interior 260; preferably formed typographically from the mortar simultaneously with the shell 290, forming chambers interior fillable chambers. The chambers may hold concrete 660 therein. The chambers may be columnar or any shape known in the art that may be formed by typographic deposition of mortar. Alternatively, the chambers may be created through the use of forms located within the interior 260. The distribution of concrete 660 into different chambers reduces the effect of hydrostatic pressure upon the panels and prevents concrete 660 from overstressing the mortar shell 260.

In one preferred non limiting embodiment, both the mortar and concrete 650 are rated at 5 ksi pressure stress. Additionally, to facilitate transport, one or more cables 606 may be affixed to array 600, for grabbing and lifting during transport. The cables may then be cut or kept attached so they may be used to facilitate the addition of a cap over the panel 100. The cables 606 may be ½ inch diameter steel cable or another cable of the type known in the art.

It should be noted that panel 100 has a height, a width and a thickness. In a preferred non-limiting embodiment as seen the figures, typographical member 200 has thickness of about one-half times the thickness of frame 102. Furthermore, the height of typographical member 200 is less than the height of frame 102 sufficient to form a planar surface of front wall 110 and facilitate assembly of a sea wall as will be discussed below. The width of typographical member 200 may be coextensive with, but preferably less than the width of frame 102 to facilitate handling of each panel 100 during transport and assembly.

In one embodiment, the frame 102 of the panel 100 has a thickness of about eight inches, a height up to ten feet, and a width of eight to ten feet. At the same time, typographical member 200 on the front wall 110 of the panel 100 has a thickness of about four inches and a width of six to twelve inches and a height less than the height of frame 102. The rebar which may be used in the supporting array 600 of the invention is preferably #5 rebar and are spaced about six to ten inches from the next adjacent rebar in the respective horizontal and/or vertical direction. Cable 606 is preferably made from steel and has a half inch diameter in a non-limiting embodiment are attached to the uppermost horizontal bar and/or any of the vertical bars.

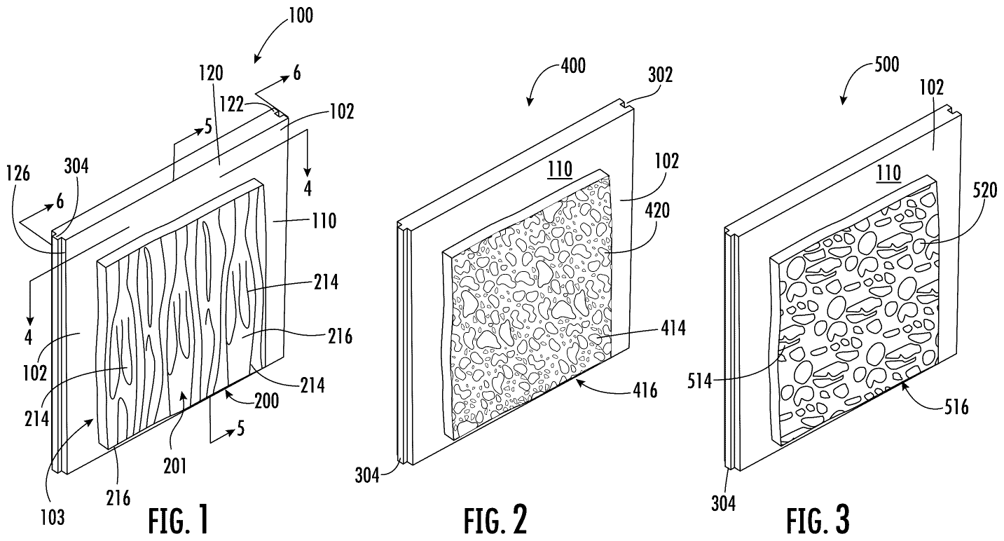

A large monolithic individual seawall panel would be overly cumbersome to maneuver and provide in place if a single panel were relied upon to protect an entire area. Panels 100 may be used in side-by-side construction to provide sufficient length for a sea wall 800. Therefore, in a preferred non limiting embodiment, as shown in FIG. 2, a first sidewall 126 may preferably be formed with a joiner 302, such as a groove. A second exterior surface if a sidewall 122 is provided with a complementary joiner 304, such as a tongue. Other known complementary joining systems are also contemplated. In a preferred non-limiting embodiment, groove 302 is dimensioned to receive a tongue 304 of an adjacent panel 100 to anchor each other and to form a multi-panel seawall. Preferably, the sidewalls of adjacent panels are generally flush. Alternatively, panels may be formed with no tongue or groove, and are assembled in abutting side by side relationship using mortar therebetween. Other means known in the art for creating a length of seawall from panels, such as the use of pilings and battered piles, may be used.

As seen from FIGS. 1-3 typographical member 200 may take many forms. It is preferred that the typographical member is sufficiently textured, has an area less than frame 102 and has at least one discontinuity or recess at least three inches deep. For example, in a non limiting embodiment of the invention, in which like structure is indicated by like numerals, as shown in FIG. 2, a panel 400 includes a frame 102 and a typographical member 420 formed therewith. Typographical member 420 has an area less than frame 102 and includes a number of projections 416, emulating rocks, separated by discontinuities 414 expressed as recesses, at least one of which is at least three inches deep. Panel 400 further forms a frame 102.

Similarly, as seen in FIG. 3, in another non limiting preferred embodiment of the invention, in which like structure is indicated by like numerals, a panel 500 includes frame 102 and a typographical member 516 formed therewith. Typographical member 516 has an area less than panel 102 and includes a number of projections 520, emulating the growth of a coral reef, separated by discontinuities 514, expressed as recesses, forming blind holes of various sizes, at least one of which is at least three inches deep. Panel 500 also forms a frame 102.

In the above embodiments of the present invention, the panels are designed with a unique feature to enhance the attachment, attraction and survival of marine life. This feature involves the incorporation of blind holes, which are depressions within the typographical portion of the panel with a minimum depth of 3 inches. These blind holes serve a crucial purpose by providing a safe haven for small marine organisms, allowing them to hide from potential predators and facilitating their attachment to the panel surface. The typographical portion of the panel, which includes the blind holes, is intentionally sized and positioned on the frame to ensure optimal effectiveness as a haven.

The panel frame extends beyond at least two and preferably three sides of the typographical portion, providing additional support and stability to the overall structure of the panel. This configuration ensures that the blind holes remain intact and functional, even in dynamic marine environments such as those characterized by strong currents, waves, and tides.

The irregularities formed in typographical member 200, coupled with the blind holes discussed earlier, create an environment conducive to marine life attachment and habitat formation. By encouraging the presence of marine organisms, they shield the wall from direct contact with the water, reducing the force of the impact of waves and currents. The organisms act as a natural buffer, absorbing and dissipating the energy of the water on the panel, which helps to mitigate erosion and damage to the seawall. A biofouling layer created by the organisms contributes to and increases the overall durability of the seawall. The organisms secrete substances, such as mucus or adhesives, which help bind them to the surface and create a cohesive layer. This layer can enhance the seawall's resistance to abrasion, erosion, and other environmental stresses. Additionally, some marine organisms produce compounds that possess antifouling or anti-corrosive properties. These compounds can inhibit the growth of other organisms or protect against the degradation of the seawall materials by preventing the formation of biofilms or reducing the impact of chemical processes.

As described below, the entire panel 100 of the invention, including the typographical member 200, without the concrete that may be added after formation, may be constructed typographically in the vertical direction, enabling the construction of the hollow interior, which would otherwise be extremely difficult if not impossible using conventional concrete form or mold technologies. Additionally, frame 110 and typographical member 200 may both be formed as a unitary member of the panel. The panel 100 itself is hollow, accommodating the array and the pour of concrete within the panel.

It should be noted that the entire panel 100, with its approximate 12-inch thickness, may be printed as a single entity using advanced 3D printing technology. This manufacturing approach ensures the seamless integration of the frame and the typographical portion, eliminating the need for separate assembly or attachment. By printing the entire panel 100 as a unified structure, the resulting seawall exhibits enhanced strength and integrity, reducing weak points or joints that may compromise the overall performance of a seawall comprising one or more panels.

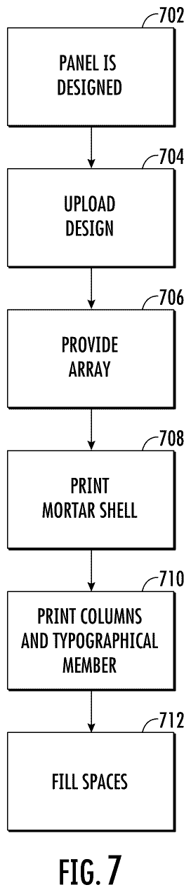

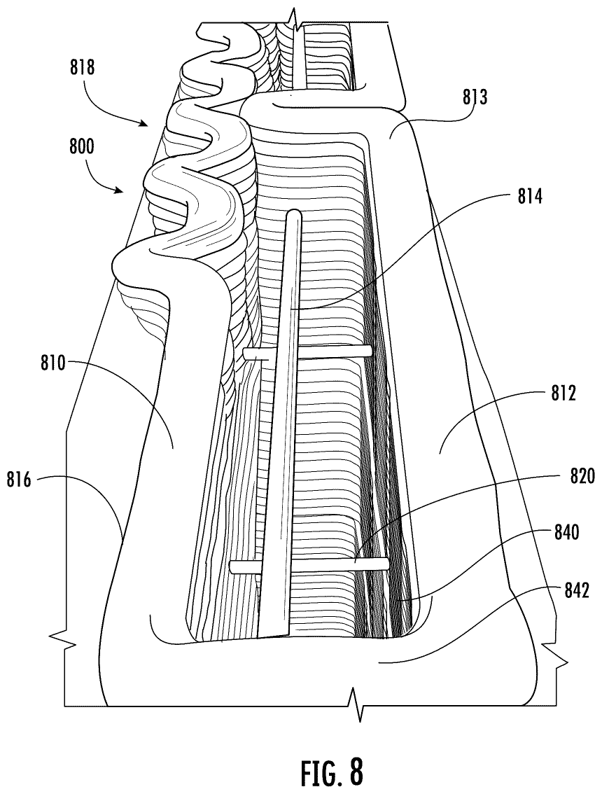

Reference is now made to FIGS. 7 and 8 in which a method for manufacturing a seawall in accordance with the invention is provided. In a first step 702 the panel is designed to promote biodiversity and prevent flooding taking into account the local microenvironment. The design may preferably conform to the following design rules: 1) the frame of the panel is about twice as thick as the typographical member; 2) The typographical member is substantially not planar and includes discontinuities in an outward facing surface of the typographical member; and 3) at least one discontinuity has a depth of at least three inches.

One non-limiting exemplary method of creating a panel pursuant to the invention is as follows as described in FIG. 7. A design for a panel is created 702. The file for the design is uploaded to the memory of a 3D printer in a step 704. A supporting array 600 is placed into position where the panel will be printed in a step 706. In a step 708 a 3D printer prints the outer shell of panel 100, about array 600 in a vertical direction with quick set mortar. In a preferred non limiting embodiment the mortar is a quick setting mortar which cures in about three minutes. The outer shell is printed as layers of mortar, each horizontal layer being about one half inch in height. As a layer corresponds to a horizontal structure of the array 600, the ends of the horizontal structure, which is rebar in a preferred non limiting embodiment, become embedded in the layer of panel 100. The attachment to the array ties the successive layers to each other, so that not every layer need be connected to a rebar. This method allows one or more internal voids to be formed within the panel. In an alternative embodiment, horizontal members of the array are added to the interior of the panel as the panel is being printed vertically. Vertical members may be inserted vertically at the top of the panel when the printing of the panel reaches a predetermined height.

In one alternative embodiment, at the same time, in a step 710 vertical columns 660a-660n and typographical member 210 are printed at the appropriate rows. The vertical columns provide voids into which concrete may be poured. The number of columns is a function of the rebar spacing within array 600. The printed panel structure is given time to cure; for example, about three minutes from time of printing in a preferred non limiting embodiment.

In a step 712, spaces between respective columns 660a-660n are filled with concrete substantially to the top of array 600. The vertical bars 604 of the array may be exposed so that a cap may be placed on top of the panel, either before or after the placement of the panel in the desired location.

An example of the invention as described by the method of FIG. 7 is illustrated in a partially constructed example provided in FIG. 8. As shown, the panel 800 is printed by extrusion monolithically, so that a front portion 810 and rear portion 812 are formed in a single process. Also, a bottom may be formed with the process or provided separately. One or more columns 813 may be formed simultaneously with the other portions being formed. The columns 813 separate the interior of the panel 800 into separate voids 840. Thus, concrete may be poured into different voids 840 separated by columns 813 or a side wall 842 and a column before or after the panel 800 is placed.

A plurality of horizontal members 814 are provided to support the panel 800. As shown, they are connected to the side walls 842 of the panel and they are placed through the one or more columns 813 that may be formed. Vertical members (not shown) may be added and tied to one or more of the horizontal members. As in other embodiments, the front surface 816 of the front portion 810 includes a typographical area having a substantially uneven surface 818 that will form habitat for sea life. One or more cross connecting supports 820, which may or may not be connected to a horizontal member 814, may also be included.

Once added, the concrete is then cured. The curing time may be between about seven to twenty-eight days. Cables may be added to extend through the top of vertical members of the array of rebar so that the panel may be transported more easily.

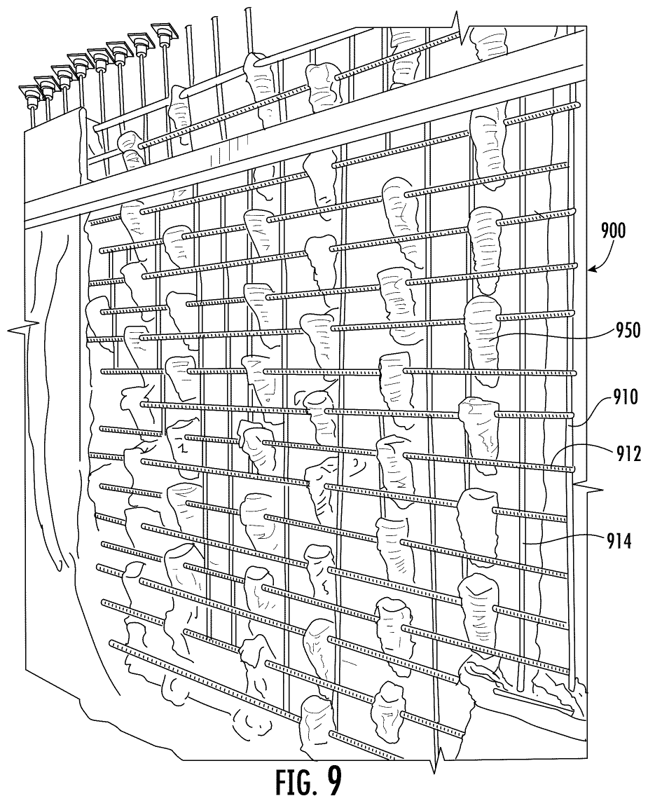

Another embodiment is provided in FIGS. 9-11. In this embodiment, the panel 900 is extrusion 3D printed vertically. As the panel 900 is printed, it forms a front portion 902, rear portion 904 and side portions 906. A bottom portion (not shown) may be created simultaneously with the front portion 902, rear portion 904 and side portions 906 or added separately. The printing of the panel 900 forms an interior void 908. The panel 900 includes a supporting structure array 910 having horizontal elements 912 and vertical elements 914. It may be preferred that the array 910 comprises rebar such as #5 galvanized rebar. The horizontal elements 912 can be added to the void 908 as the panel is printed vertically. The mortar forming the panel 900 would hold the elements in place. In addition, cable lifts such as those made of stainless steel and ½ inch in diameter may be placed between the horizontal elements 912 so that they remain secured in their orientation. The horizontal elements 912 may be preferred to be spaced approximately six to ten inches apart. As the printing of the panel reaches a predetermined height, vertical elements 914 may be added into the void 908 and tied to the horizontal element 912 closest to a top portion of the panel 900. The vertical elements 914 would be spaced apart at the approximate same distance as the horizontal elements 912. The panel 900 itself may be preferred to be approximately 8 inches thick, 10 feet wide and 8 feet, 9 inches high.

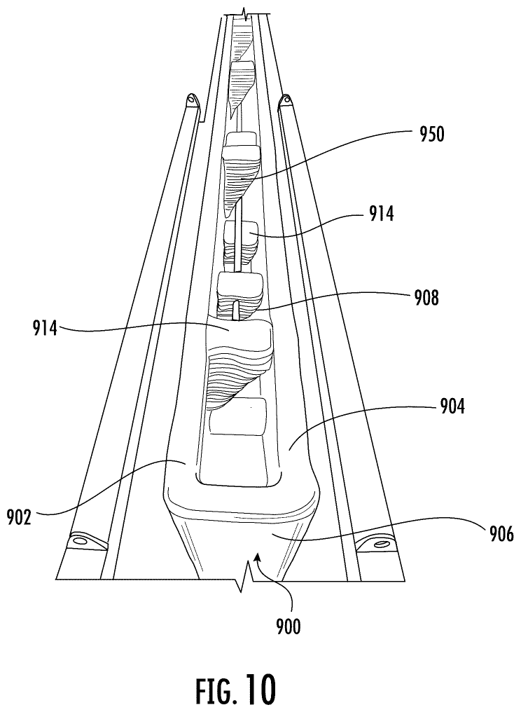

As shown in FIG. 10, several connector elements 950 may be preferred to be printed in the interior void 908 of the panel 900 during the printing of the panel 900. As shown in FIG. 9, the connector elements 950 may preferably have elements of the array 910 go through them. As shown, the horizontal elements 912 go through the connector elements 950; however, the vertical elements 914 may also go through the connector elements 950. The connector elements 950 may be Italian cream horn shaped as shown in FIGS. 9, generally triangular or wedge shaped as shown in FIG. 10, or any other shape known in the art.

The presence of the connector elements 950 allows the panel to be filled with concrete with a continuous pour, making the pour easier and more efficient. The inclusion of the connector elements reinforces the panel so that the effect of hydrostatic pressure against the panel is diminished. Thus, the connector elements 950 also allow the panel 900 to operate longer without breaking from the forces it withstands when installed.

Although not shown in FIG. 10, the panel 900 when printed may further include a substantially uneven surface to serve as a habitat for marine creatures as described earlier on a front portion 902 of the panel. The uneven surface may mimic the root structure of mangrove trees, have coral or rock texture or have ridges and divots approximately 3 to 5 inches in depth. The vertical elements 914 of the array 910 may be exposed so that a cap may be placed on top of the panel 900, either before or after the placement of the panel in the desired location.

It may also be preferred that the uneven surface of the panel 900 begins two feet from a bottom edge of the panel, so that the uneven surface is exposed if the panel settles into the mudline when installed.

It should also be noted that during manufacture, sensors for monitoring or measuring the environment may be embedded in either one of the panel or the typographical member. Sensors capable of measuring water quality and other relevant parameters can be incorporated within its structure. This integration enables continuous monitoring and analysis, providing valuable data for environmental assessment and management. A sensor may be attached to the panel, for example, one foot above the seabed, allowing water to flow through the sensor and enabling the sensor to be easily hoisted up and calibrated. As shown. a seawall constructed of panels made in accordance with the invention may be formed to adapt to variety of environments to attract varied sea life, and provide shelter for animals to evade predators. The materials used may be chosen to ensure that each panel is free from toxins.

By using the panel constructed as described above, the surface of the panel itself absorbs CO₂ from the environment. Additionally, by providing a habitat to marine organisms, when skeletons attached to the panel are left behind, those skeletons assimilate carbon. Artificial reefs strengthen over time because of a process (science) called “marine biofouling”, where marine organisms such as corals, oysters, mussels, barnacles, and certain types of algae attach themselves to a structure. These organisms reinforce the structure of the reef, making it more robust. Coral growth on an artificial reef can concrete the structure together, making it more resistant to wave action and currents. As organisms attach to our seawall, due to the unique design of our structures that will attract life, the presence of the organisms will also strengthen over seawall over time through the process of marine biofouling.

Because of the 3D printing process used to manufacture the panels, all of the materials emanating from the printer becomes part of the wall; effectively eliminating waste during the panel manufacturing process.

By creating the structure for a reef on the panel and deploying in situ, biocalcification occurs. Biocalcification is a natural process by which marine organisms, such as corals and shell-forming creatures like oysters, extract calcium carbonate (CaCO3) from the surrounding water to build their skeletons or shells. This process involves the uptake of dissolved inorganic carbon (DIC) from the water, which consists of carbon dioxide (CO2) and bicarbonate ions (HCO3-), and the conversion of this carbon into solid calcium carbonate structures. In the context of our living seawalls, the biocalcification process occurs when marine organisms, attracted to the panels, attach and grow on their surfaces. As these organisms grow, they secrete calcium carbonate, which gradually accumulates and reinforces the structure of the seawall. Over time, as more organisms settle on the panels and deposit their skeletons, the seawall becomes increasingly robust and durable. The biocalcification process also offers a significant environmental benefit by sequestering carbon dioxide from the water and converting it into solid calcium carbonate. This sequestration helps mitigate the effects of carbon emissions on the environment by removing CO2 from the water column and locking it away in the form of the skeletons deposited on the seawall. This process effectively reduces the carbon dioxide concentration in the surrounding water, contributing to the overall carbon sequestration capacity of the living seawalls. As a result, the seawall constructed in accordance with the invention not only provide structural protection against flooding and wave impacts but also serve as a means to actively sequester carbon from the marine environment. This dual functionality promotes the growth of healthy marine ecosystems while mitigating the effects of climate change, making the seawalls an environmentally beneficial solution for coastal communities.

In summary, the present invention introduces a novel panel design and method of manufacture for seawalls, offering improved structural features, enhanced biodiversity promotion, and efficient manufacturing processes. Furthermore, the present invention provides improved operational efficiency, simplifying the handling and installation process of the seawall panels.

Through the integration of innovative elements, such as the typographical member, hollow interior elements, sensors, and 3D printing technology, the panel demonstrates the potential to revolutionize seawall construction and its ecological impact.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A panel for a seawall comprising:
a front wall having a front surface;
a rear wall coupled to and spaced from the front wall; an interior void formed between the front wall and rear wall;
a generally smooth frame formed on the front surface of the front wall; the frame having a first area and forming a frame front surface,
a typographical member disposed on the frame having a second area, less than the first area; the typographical portion extending in a direction away from the frame and forming an uneven surface.

2. The panel of claim 1, wherein the panel is formed in one piece through 3D printing.

3. The panel of claim 1, wherein the typographical member comprises a habitat for marine life.

4. The panel of claim 1, wherein the habitat for marine life comprises a discontinuity of at least three inches.

5. The panel of claim 2, further comprising a supporting array disposed within the interior void.

6. The panel of claim 5, wherein horizontal elements of the supporting array are placed in the interior void during 3D printing.

7. The panel of claim 6, wherein vertical elements of the supporting array are placed in the interior void during 3D printing after horizontal elements have been placed in the interior void, and wherein the vertical elements are tied to an at least one horizontal element in the array.

8. The panel of claim 1, further including connector elements located in the interior void connecting an interior surface of the front wall and an interior surface of the rear wall, wherein the void is capable of being filled.

9. The panel of claim 8, wherein the connector elements are attached to horizontal elements of the array in the interior void.

10. The panel of claim 9, wherein the connector elements are generally conical in shape.

11. The panel of claim 1, wherein the front wall and rear wall are formed from mortar, and wherein concrete being disposed in the interior void.

12. A method for forming a panel for a seawall, the panel having an outer shell comprising a front wall, a rear wall, and frame and a typographical member disposed on the front wall, comprising the steps of:
creating a panel design
wherein the typographical member is designed to be substantially non planar and include discontinuities in an outward facing surface of the typographical member;
wherein the panel design includes an interior void.
uploading the panel design to the memory of a 3D printer;
beginning printing an outer shell of the design from mortar with the 3D printer, in a vertical direction;
adding spaced apart horizontal elements for a support array at intervals during printing; and
adding spaced apart vertical elements for a support array at a predetermined height of vertical printing.

13. The method of claim 12, wherein the panel design further includes a plurality of horizontal connectors located in the interior void attached to the front wall and the rear wall.

14. The method of claim 13, wherein the horizontal connectors form an array within the interior void.

15. The method of claim 14, wherein the interior void is continuous.

16. A panel for a seawall, wherein the panel created by the method of claim 12.
